(19) United States
(12) Patent Application Publication
(10) Pub. No.: US 2011/0261454 A1
(43) Pub. Date: Oct. 27, 2011

(54) All-Fiber Optical Isolator

(75) Inventors: Shibin Jiang, Tucson, AZ (US); Jihong Geng, Tucson, AZ (US); Zhuo Jiang, Tucson, AZ (US)

(73) Assignee: ADVALUE PHOTONICS, INC., Tucson, AZ (US)

(21) Appl. No.: 13/172,623

(22) Filed: Jun. 29, 2011

Related U.S. Application Data
(63) Continuation-in-part of application No. 12/778,712, filed on May 12, 2010.
Application No. 12/778,712 is a continuation-in-part of application No. 12/628,914, filed on Dec. 1, 2009.

(51) Int. Cl. G02F 1/09

(52) U.S. Cl. 359/484.03

(57) ABSTRACT

An all-fiber Faraday rotator including a plurality of optical fibers doped, at unusually high concentrations of at least several tens of percent, with rare-earth oxides, an all-optical-fiber optical isolator employing a polarization-maintaining fiber-optic splitter, and a method of optically-isolating a laser source from unwanted feedback with such an optical isolator. In a case where the doping concentration exceeds 55 weight-%, the length of the Faraday rotator achieving a 45-degree rotation of the polarization vector of light guided by an optical fiber does not exceed approximately 10 cm.

### CROSS REFERENCE TO RELATED APPLICATIONS

This application claims the benefit of U.S. patent application Ser. No. 12/778,712, filed May 12, 2010 and titled “Highly Rare-Earth Doped Fiber Array” and U.S. patent application Ser. No. 12/628,914, filed Dec. 1, 2009 and titled “Highly Rare Earth Doped Fiber.” The contents of each of these applications are incorporated by reference herein in their entirety, for all purposes.

### STATEMENT REGARDING FEDERALLY SPONSORED RESEARCH OR DEVELOPMENT

This invention was made with government support under contract Nos. FA8650-09-C-5433, FA9451-10-D0233, and FA9451-11-C-038. The government has certain rights in the invention.

### TECHNICAL FIELD

The present invention relates to fiber-optic based Faraday rotators and, more particularly, to Faraday rotators, fiber-optic isolators and fiber-optic polarization rotators utilizing highly rare-earth doped optical fibers.

### BACKGROUND ART

Faraday rotation, or the Faraday effect, is a magneto-optical phenomenon that, as a result of interaction between light and a magnetic field in a medium, causes a rotation of a polarization vector of light wave by a degree that is linearly proportional to the strength of a component of the magnetic field collinear with the direction of propagation of light. For example, the Faraday effect causes left and right circularly polarized light waves to propagate at slightly different speeds, a property known as circular birefringence. As given linear polarization vector can be presented as a composition of two circularly polarized components, the effect of a relative phase shift, induced by the Faraday effect onto the linearly polarized light wave, is to rotate the orientation of the light wave's vector of linear polarization.

The empirical angle of rotation of a linear polarization vector of a light wave is given by β=VBd, where β is the angle of rotation (in radians), V is the Verdet constant for the material through which the light wave propagates, B is the magnetic flux density in the direction of propagation (in teslas), and d is the length of the path (in meters). The Verdet constant reflects the strength of the Faraday effect for a particular material. The Verdet constant can be positive or negative, with a positive Verdet constant corresponding to a counterclockwise rotation when the direction of propagation is parallel to the magnetic field. The Verdet constant for most materials is extremely small and is wavelength-dependent. Typically, the longer the wavelength of light, the smaller the Verdet constant. It is appreciated that a desired angle of rotation can be achieved at a shorter distance during propagation through a material the Verdet constant of which is high. One of the highest Verdet constant of −40 rad/T·m at 1064 nm is found in terbium gallium garnet (TGG). This allows a construction of a Faraday rotator, which is a principal component of a Faraday isolator, a device that transmits light in only one direction.

Faraday rotators and Faraday isolators of the related are bulk, stand-alone devices that are not well suited for optical integration (such as, for example, integration with waveguide-based or fiber-optic based components) and, when incorporated into an integrated optical system, require free-space optical coupling with other components of the integrated system, thereby limiting a degree of the system miniaturization and causing coupling losses.

### SUMMARY OF THE INVENTION

Embodiments of the present invention disclose a fiber-optic (FO) device and a method for operating a FO device. According to one embodiment, an FO device has first and second light ports defining a light-path therebetween and includes a multicomponent-glass optical fiber (having two ends and containing, in the amount between 55 weight-percent and 85 weight-percent, a rare-earth oxide dopant selected from the group consisting of Pr₂O₃, Nd₂O₃, Pm₂O₃, Sm₂O₃, Eu₂O₃, Gd₂O₃, Tb₂O₃, Dy₂O₃, Ho₂O₃, Er₂O₃, Tm₂O₃, Yb₂O₃, La₂O₃, Ga₂O₃, Ce₂O₃, and Lu₂O₃), a first polarization-maintaining (PM) optical fiber beam splitter (a terminal of which is fusion-spliced with one end of the multicomponent-glass optical fiber and which defines the first port of the FO device) and a second PM optical beam splitter (a terminal of which is fusion-spliced with another end of the multicomponent-glass optical fiber and which defines the second port of the FO device). The light-path defined between the first and second ports of the FO device is devoid of free-space regions.

In another embodiment, the FO device additionally includes a magnetic cell configured to enclose the multicomponent-glass optical fiber. In a related embodiment, the FO device is configured to operate as an FO-based Faraday isolator that is spatially continuous and devoid of stand-alone optical elements. In yet another embodiment, a plurality of such FO-devices may be configured to operate as an all-FO Faraday isolator array. Alternatively or in addition, the multicomponent-glass optical fiber of the FO device may include at least one of glass network formers selected from the group consisting of SiO₂, GeO₂, P₂O₅, B₂O₃, TeO₂, Bi₂O₃, and Al₂O₃; a glass network intermediate; and a glass network modifier. In a related implementation, the FO device is configured to rotate a vector of polarization of linearly-polarized light propagating through the FO device by an angle of 45 degrees, and a length of the multicomponent optical fiber of such FO device does not exceed approximately (i.e., within +/−10% or so) the length of 10 cm.

Embodiments of the present invention additionally disclose a fiber-optic (FO) beam-splitter having first and second ports, that features a first FO-component, an intermediate FO-component that is fusion-spliced with the first FO-component at one end, and a second FO-component that is fusion-spliced with another end of the intermediate FO-component. The first FO-component defines a first port of the FO beam-splitter and has at least three branches operably integrated at a first junction that is configured to spatially redirect a first fiber mode (that propagates through the first FO component and is characterized by a first polarization vector) into at least one such branch based on polarization state of the guided fiber mode. The second FO-component defines a second port of the FO beam-splitter and has at least three branches operably integrated at a second junction that is configured to spatially redirect a second fiber mode (that propagates through the second FO-component and is characterized by a second polarization vector that forms an angle with the first polarization vector) into at least one such branch based on polarization state of the guided fiber mode.

In a specific embodiment, the angle of rotation of the polarization vector upon the propagation of light having such polarization through a 5 cm long intermediate FO-component is 45 degrees. In another specific embodiment, an optical path defined between the first and second ports of the FO beam splitter is devoid of free-space regions. In a related embodiment, the FO beam splitter is configured to assure that light guided by the FO beam splitter from the second port through the intermediate FO-component is redirected, by the first junction, towards a branch of the first FO-components that is different from the first port.

Additionally, embodiments of the present invention disclose a FO beam-splitter that is configured as an all-FO Faraday isolator. Alternatively, embodiment provide a plurality of FO beam-splitters configured as an all-FO Faraday isolator array.

Disclosed embodiments additionally provide a method for operating a fiber-optic (FO) device having first and second light ports and a light-path defined between the first and second light ports. Such method includes transmitting light from the first port through a first polarization-maintaining (PM) FO beam-splitter to a multicomponent-glass optical fiber having (i) two ends, one of which is fusion-spliced with the first PM FO beam-splitter, and (ii) a rare-earth oxide dopant, in the amount between 55 weight-percent and 85 weight-percent, selected from the group consisting of Pr₂O₃, Nd₂O₃, Pm₂O₃, Sm₂O₃, Eu₂O₃, Gd₂O₃, Tb₂O₃, Dy₂O₃, Ho₂O₃, Er₂O₃, Tm₂O₃, Yb₂O₃, La₂O₃, Ga₂O₃, Ce₂O₃, and Lu₂O₃. The method additionally includes transmitting light through the multicomponent-glass optical fiber to a second PM FO beam-splitter that is fusion-spliced with another end of the multicomponent-glass optical fiber and, upon such transmission, rotating a polarization vector of said light by 45 degrees. The method further includes transmitting light through the second PM FO beam-splitter through a second port to a field-of-view outside the second PM FO beam-splitter.

In a specific embodiment of the method, transmitting light from the first port through the first PM FO beam-splitter to a multicomponent-glass optical fiber includes transmitting light to a multicomponent-glass optical fiber that contains at least one of glass network formers selected from the group consisting of SiO₂, GeO₂, P₂O₅, B₂O₃, TeO₂, Bi₂O₃, and Al₂O₃; a glass network intermediate; and a glass network modifier. In another specific embodiment, transmitting light through the FO device between its first and second ports includes transmitting light along an optical path that is devoid of free-space regions. In yet another embodiment, transmitting light through the multicomponent-glass optical fiber to a second PM FO beam-splitter feature transmitting light through a length of the multicomponent-glass optical fiber that does not exceed 5 cm.

### BRIEF DESCRIPTION OF THE DRAWINGS

Implementations of the invention will become more apparent from the detailed description set forth below when taken in conjunction with the drawings, in which like elements bear like reference numerals.

FIG. 1 is a schematic of an exemplary prior art free-space Faraday isolator;

FIG. 2 is a schematic of an exemplary prior art fiber pigtailed free-space Faraday isolator;

FIG. 3 shows an embodiment of the present invention;

FIG. 4 is a cross-sectional view of an exemplary highly rare-earth doped fiber for use with an embodiment of the present invention;

FIG. 5 is a graph of transmission spectrum of terbium-doped glass;

FIG. 6 shows schematically an alternative embodiment of the present invention;

FIG. 7 is a graph of the magnetic filed distribution corresponding to the embodiment of FIG. 6;

FIGS. 8, 9, 10, 11, 12 show various embodiments of the present invention;

FIG. 13 is a cross-sectional perspective view of an exemplary prior art Faraday rotator;

FIG. 14 demonstrates schematically another embodiment of the invention.

FIGS. 15 A, 15B illustrate performance of a polarization-maintaining fiber-optic splitter/combiner;

FIG. 16 depicts, in perspective view, another embodiment of the present invention utilizing a splitter/combiner of FIGS. 15A, 15B.

FIGS. 17A, 17B show schematically alternative embodiments of the present invention.

### DETAILED DESCRIPTION OF SPECIFIC EMBODIMENTS

Throughout the following description, this invention is described in reference to specific embodiments and related figures, in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the terms “in one embodiment, “in an embodiment,” and similar language throughout this specification may, but do not necessarily, all refer to the same embodiment.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention that are being discussed.

An optical isolator is a device that allows light to be transmitted in only one direction. A Faraday isolator is a specific type of optical isolator that employs a Faraday rotator, which is a magneto-optical device varying the polarization of light upon light's traversing a medium that is exposed to a magnetic field.

A Faraday isolator is polarization dependent and includes a Faraday rotator device sandwiched between two optical polarizers. A simple illustration of the operation of a Faraday isolator if offered in reference to FIG. 1, showing a conventional embodiment of a Faraday isolator 100 employing a free-space Faraday rotator device 104 (including a cell 104a creating a magnetic field throughout thereof, and a material 104b appropriately chosen to have a high Verdet constant) and input and output linear polarizers 108, 112 (denoted so in reference to a direction of forward propagation of light, z-axis), having respective transmission axes shown with arrows 108a, 112a. A portion 116 of input light 120, having a linear polarization parallel to the vector 108a, upon passing through the input polarizer 108, is coupled into the rotator device 104. The Faraday rotator 104 rotates the vector of polarization of light 116 by, typically, 45 degrees and passes the output light 122 towards the output polarizer (also referred to as analyzer) 112. A component, of light 122, having polarization collinear with the transmission axis 112a, emerges at an output of the polarizer 112 as light 124. Any light beam propagating in the opposite direction (i.e., in the −z direction), for example, back-reflected light, is rotated an additional forty-five (45) degrees when it passes through the Faraday rotator 104a second time, thereby emerging from the rotator 104 with a polarization vector that is orthogonal to the transmission axis of the polarizer 108. The polarizer 108, therefore, blocks the back-reflected light. When the polarization vector of input light 120 is aligned to be parallel to the transmission axis 108a, and when the transmission axis 112a is aligned to be parallel to the rotated vector of polarization of light 122, emerging from the Faraday rotator 104, the attenuation of light upon the propagation through the Faraday isolator 100 is minimized.

Typically, a Faraday rotator such as the Faraday rotator device 104 includes a terbium gallium garnet (TGG) crystal or terbium-doped glass (element 104b of FIG. 1) inserted into a magnetic tube (element 104a of FIG. 1). It is appreciated that the magnetic flux density of the magnetic tube 104 as should be strong enough to produce a forty-five (45) degree polarization rotation when the light passes through the Faraday rotator 104. In some conventional embodiments, the magnetic tube 104a is made of a ferromagnetic material, while other related art employs a tube of any material exposed to a magnetic field.

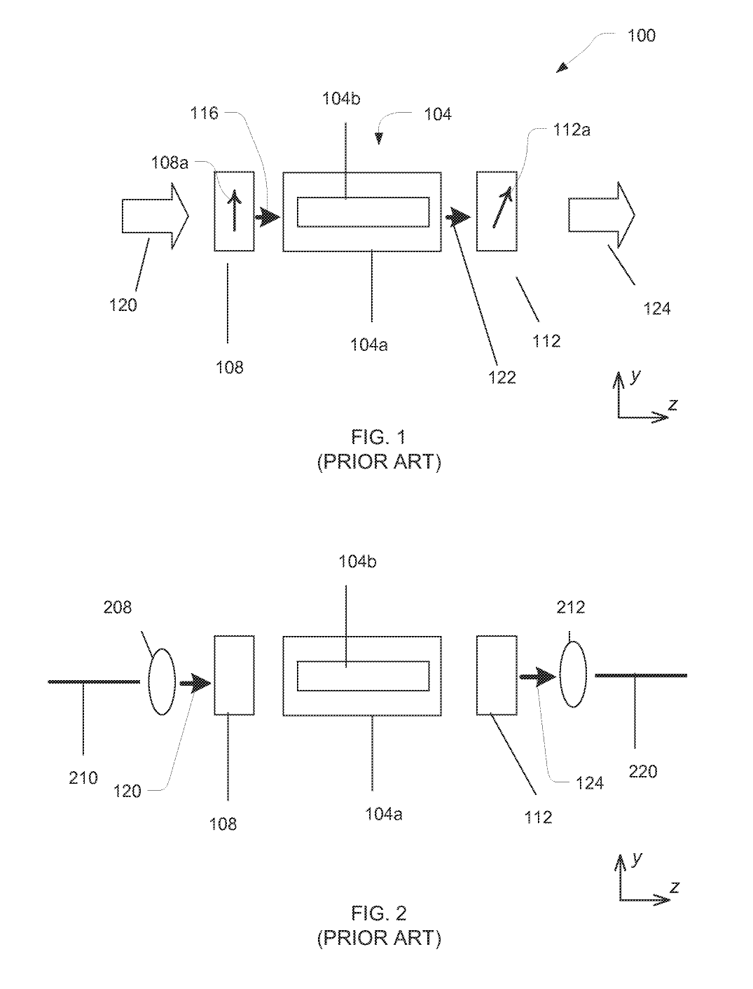

As mentioned above, commercially available Faraday isolators are free-space devices, in which light passes through a region of free-space before being coupled into the Faraday rotator. Simply put, a free-space isolator, such as a conventional Faraday isolator 100 of FIG. 1, has free space separating its components. Another example, shown in FIG. 2, presents a schematic of an another free-space Faraday isolator of the related art, which intakes input light 120 through a coupling optic 208 from an input fiber 210, and which outcouples the light 124 through an optic 212 into an out[put fiber-optical component 220. This so-called fiber-pigtailing of a conventional bulk free-space Faraday isolator device 100 is employed to facilitate the optical coupling between the device 100 and a portion of the integrated optical system (not shown). FIG. 13 presents, in a cross-section, a perspective view of an exemplary Faraday rotator device of the related art, such as the device 104 of FIGS. 1 and 2.

The development of fiber isolators has become critical given recent advancements in high powered fiber lasers. Fiber lasers generating as much as ten (10) kilowatts of output power have been demonstrated, enabling a wide range of new applications including laser welding, laser cutting, laser drilling, and military defense applications. Even though these fiber lasers have been successfully introduced into industry, much of their operational potential is not realized due to the limitations of the currently-available optical isolators. For the moment, free-space fiber-pigtailed isolators, such as that depicted in FIG. 2, are being used. Incorporation of these free-space isolators into a bigger optical system requires various precise operations (such as, for example, fiber termination, lens alignment, and recoupling of light from a fiber laser source to a fiber optic), each of which reduces the overall performance of the fiber laser. Not only does the use of a free-space isolator limits the power of a fiber laser to about 20 W, but it also reduces the ruggedness and reliability of the overall system, which are two main advantages offered by a fiber laser over a free-space solid-state laser. Embodiments of the invention stem from the realization that an optical isolator implemented as an all-fiber-optic-component device, an optical path of which is devoid of free space, not only facilitates the use of such isolator with a fiber laser source by allowing a user to take advantage of full spectrum of operational characteristics of the fiber laser, but also drastically reduces both the cost of production and a probability of malfunction of the resulting all-fiber-optic laser system.

The related art does not appear to disclose a fiber-optic based Faraday rotator device or a Faraday isolator system employing such a fiber-optic based Faraday rotator device. Since fiber-optic elements doped with rare-earth materials of the related art conventionally have a doping concentration on the order of a few weight percent or even lower, which corresponds to a low Verdet constant. For example, the 2 weight %-doped silica glass has a Verdet constant of approximately 1 rad/T·m. A Faraday rotator device employing such a fiber-optic component would require the fiber-optic component to be extremely long, on the order of one meter, before a rotation of a linear polarization vector of light guided by such fiber-optic component reaches 45 degrees. Accordingly, the dimensions and weight of a magnet cell required to effectuate a performance of such a rotator become cost-wise and operationally prohibitive. Such exorbitantly long required lengths of fiber optic may explain why the related art has not been concerned with fiber-optic based implementations of a Faraday rotator and/or Faraday isolator devices. In contradistinction with the related art, a level of doping of fiber-optic components with rare-earth materials is significantly increase, greater than 55% (wt), or, preferably, greater than 65% (wt.), and more preferably greater than 70% (wt.). In a specific embodiment, the doping concentration is between 55%-85% (wt.). These high levels of doping assure that resulting Verdet constants, of or about 30 rad/T·m facilitate the fabrication of a fiber-optic based Faraday rotator unit on the order of 5 cm.

Embodiments of the present invention employ either a single-mode fiber or a multi-mode fiber, that is doped with rare-earth material(s), employed in construction of a Faraday rotator element. In one embodiment, the fiber-optic based Faraday rotator is fusion-spliced with a fiber-based polarizing element (referred to hereinafter as fiber-optic polarizer) to form an all-fiber-optic isolator system. Fusion spicing, as known in the art, facilitates the collinear integration of two optical fiber component end-to-end using heat treatment in such a manner that light passing through a first fiber-optic component enters the second component without passing through free space and with minimized optical losses (i.e., scattering and reflection at a location of the splice is optimized). In a specific embodiment, embodiments, the power input of the Faraday rotator element is greater than 100 watts. Moreover, embodiments of the present invention implement all-fiber-optic polarizing elements which, when used in conjunction with the all-fiber-optic Faraday rotator embodiment, provide a novel all-fiber-optic isolator system.

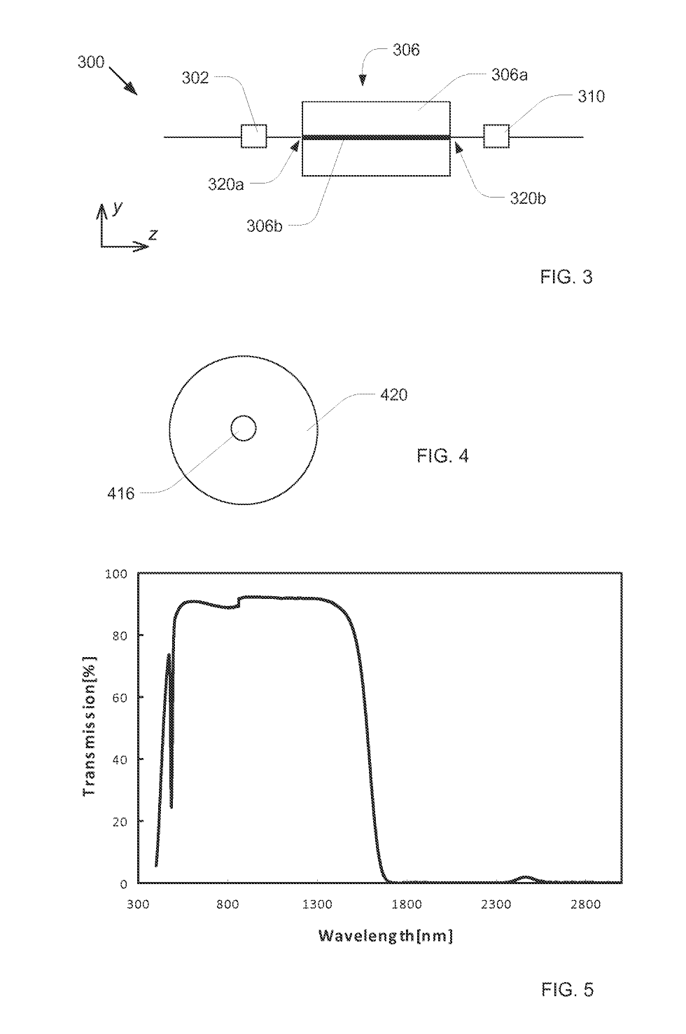

Turning now to FIG. 3, illustrating an embodiment 300 of an all-fiber-optic isolator device including, in the order encountered by light propagating through the device 300 along the z-axis, a first fiber-optic based polarizer 302, a Faraday rotator 306 containing a fiber optic component 306b disposed within a magnetic cell 306a (shaped, for example, as a tube), and a second fiber-optic based polarizer 310. The ends of the fiber-optic components 306b are fusion-spliced with corresponding ends of the polarizers 302, 310 (as shown schematically with by fiber-fusion splicing joints 320a, 320b), thereby creating an al-fiber-optic based device. The fiber optic component 306, used in a Faraday rotation 306, is doped with a rare-earth oxide such as at least one of Pr₂O₃, Nd₂O₃, Pm₂O₃, Sm₂O₃, Eu₂O₃, Gd₂O₃, Tb₂O₃, Dy₂O₃, Ho₂O₃, Er₂O₃, Tm₂O₃, Yb₂O₃, La₂O₃, Ga₂O₃, Ce₂O₃, and Lu₂O₃.

In a specific embodiment, the component 306b includes terbium-doped glass. FIG. 5, showing a transmission spectrum of glass doped with 55 weight-percent of Tb₂O₃, illustrates that, while Tb₂O₃ exhibits a Verdet constant that is the highest among those corresponding to the rare-earth oxides, this material also absorbs light in spectral regions near 1.5 microns and 2 microns.

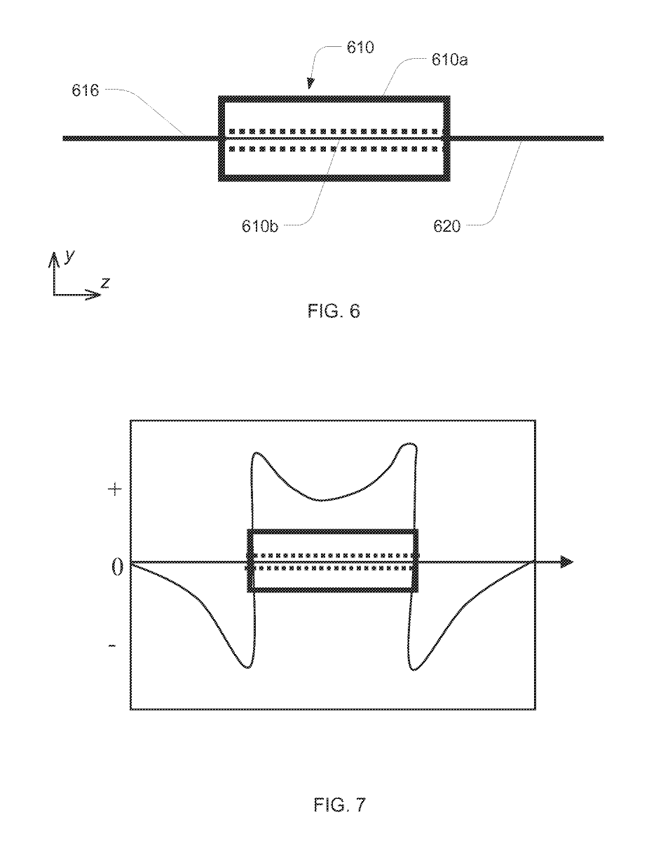

An alternative embodiment employing a Faraday-rotator 610 of a all-fiber-optic isolator (not shown) of the invention is depicted schematically in FIG. 6. Here, the degree of Faraday rotation of the polarization vector of light propagating through the embodiment 606 is increased by employing two auxiliary fiber optic components corresponding glass materials of which have Verdet constants with opposite signs. A fiber optic component 610b made of a first glass material is employed, according to the embodiment, inside the magnetic cell 610b as a component of the Faraday rotator 610. Fiber optic components 616, 620 that are made of a second type of glass material (or, alternatively, of different, second and third, types of glass) are placed at the input and output of the Faraday rotator 606, respectively, and are linearly (end-to-end) integrated, for example via fusion splicing, to create a composite uninterrupted fiber-optic channel that includes a sequential combination of the fibers 616,610b, 620. Glass material(s) of each of the fiber-optic components 616, 620 has Verdet constant(s) with one sign, while the glass material of which the fiber-optic component 610b is made has a Verdet constant with a different sign. For example, the glass of fiber-optic component 610b within the magnetic tube 610a has a negative Verdet constant, while glass material(s) of the components 616, 620 have a positive Verdet constant. In a specific embodiment, the fiber components 616, 620 having a positive Verdet constant are doped with at least one of Yb2O3, Sm2O3, Gd2O3, and/or Tm2O3, and the fiber component 610b having a negative Verdet constant is doped with Tb2O3. FIG. 7 depicts the magnetic field distribution of the all-fiber isolator of FIG. 6.

It is appreciated that an embodiment where the signs of the Verdet constants are reversed (for example, the fiber material inside the cell 610a having a positive Verdet constant, while the fiber-optic component outside the cell 610a have negative Verdet constants) is also within the scope of the invention.

In further reference to FIG. 3, the material of the fiber-optic component 306b used in a Faraday rotator 306 is be doped, in one embodiment, with at least one of La₂O₃, Ga₂O₃, Yb₂O₃, Ce₂O₃. It is preferred that fiber lasers used with such an embodiment of the Faraday rotator operate at wavelength(s) near 1.5 micron or near 2 microns.

In further reference to FIG. 3, in another related embodiment the fiber-optic component 306b includes a multicomponent glass. Specifically, the glass material of which the core and/or cladding of such multicomponent-glass fiber optic 306b is made may contain, for example, silicate glass, germanate glass, phosphate glass, borate glass, tellurite glass, bismuth glass, and aluminate glass. In addition or alternatively, the multicomponent glass of the fiber-optic component 306 may include glass network formers, intermediates, and modifiers. In certain embodiments, the network structure of glass includes certain types of atoms that can significantly change the properties of the glass. Cations can act as network modifiers, disrupting the continuity of the network, or as formers, which contribute to the formation of the network. Network formers have a valence greater than or equal to three and a coordination number not larger than four. Network intermediates have a lower valence and higher coordination number than network formers. In a specific embodiment, one or more glass network formers of the multicomponent glass of the fiber-optic component 306b of FIG. 3 include at least one of SiO₂, GeO₂, P₂O₅, B₂O₃, TeO₂, Bi₂O₃, and Al₂O₃.

TABLE 1

| | Composition | | | | |
|---|---|---|---|---|---|
| | SiO₂ | Al₂O₃ | B₂O₃ | CeO₂ | |
| | | | | | Tb₂O₃ |
| wt % | 9.9 | 0.9 | 7.4 | 0.1 | 72.7 |
| wt % | 13.3 | 13.9 | 10.7 | 0 | 62.2 |
| wt % | 12.2 | 13.3 | 10 | 0 | 64.5 |
| | | | | | Yb₂O₃ |
| wt % | 14.8 | 16.5 | 10.3 | 0.1 | 58.3 |
| | | | | | Er₂O₃ |
| wt % | 15.1 | 16.8 | 10.5 | 0.1 | 57.6 |
| | | | | | Yb₂O₃ |
| wt % | 16 | 17.8 | 11.1 | 0.1 | 55 |

Table 1 presents non-limiting examples of terbium-doped silicate glasses, erbium doped glasses, and ytterbium-doped silicate glasses that can be used with embodiments of the present invention.

Turning now to FIG. 4, a cross-sectional view of an exemplary highly rare-earth doped fiber-optic pre-form for fabrication of a fiber-optic component (such as the component 306b of FIG. 3) of a Faraday rotator of the present invention shows a glass core rod 416 is surrounded by a glass cladding tube 420. The outer diameter of the core 416 is the same as the inside diameter of the cladding 420 such that there is no void or gap between the core and the cladding. A fiber-optic component for a fiber-optic based Faraday rotator embodiment of the invention is manufactured using a rod-in-tube fiber drawing technique. The core glass rod 416 is drilled from a bulk highly rare-earth doped glass and the outer surface of the core glass rod 416 is polished to a high surface quality. The cladding glass tube 420 is fabricated from another piece of rare-earth doped glass with a refractive index that is slightly lower than that of the rod 416. The inner and outer surfaces of cladding glass tube 420 are polished to a high surface quality. After, the rod 416 is placed in the glass tube 420 and then the combination of the two is heated until the tube shrinks around the rod, followed by a well-known fiber-drawing procedure.

FIG. 8 illustrates an embodiment 800 employing an array of isolators each of which is structured according to an embodiment of the present invention. As shown, the array 800 includes fiber-optic based polarizers 802, 804, 806, 812, 814, and 816 linearly integrated (for example, with the use of fusion splicing) with fiber-optic elements 822b, 824b, and 826b positioned inside the magnetic tube 330a of the Faraday rotator device 330. In one embodiment, the inner diameter of the magnetic tube 330a is about 1 mm to about 10 mm. In a specific embodiment, the outer diameter of each of the fiber optic components 822b, 824b, and 826b is about 0.125 mm.

In one embodiment, the fiber-optic components 822b, 824b, and 826b may all be made of the same type of glass doped with the same rare-earth oxides. Alternatively, however, in a different embodiment, these components are made of different types of glass and are doped with different rare-earth oxides. Due to different type of doping, in such an alternative embodiment, these components 822b, 824b, and 826b may be used at different wavelengths. For example, a first fiber-optic component will absorb light in a specific spectral bandwidth while a second component will absorb light in a different spectral bandwidth. In yet another embodiment, the fiber-optic components 822b, 824b, 826b represent fiber optic elements made of the same type of glass but doped with a given rare-earth oxide of different concentrations. In one embodiment, fiber-based polarizers 802, 804, 806, 812, 814, 816 are all the same type of fiber-based polarizers. Generally, however, optical properties of fiber-based polarizers 802, 804, 806, 812, 814, 816 may differ.

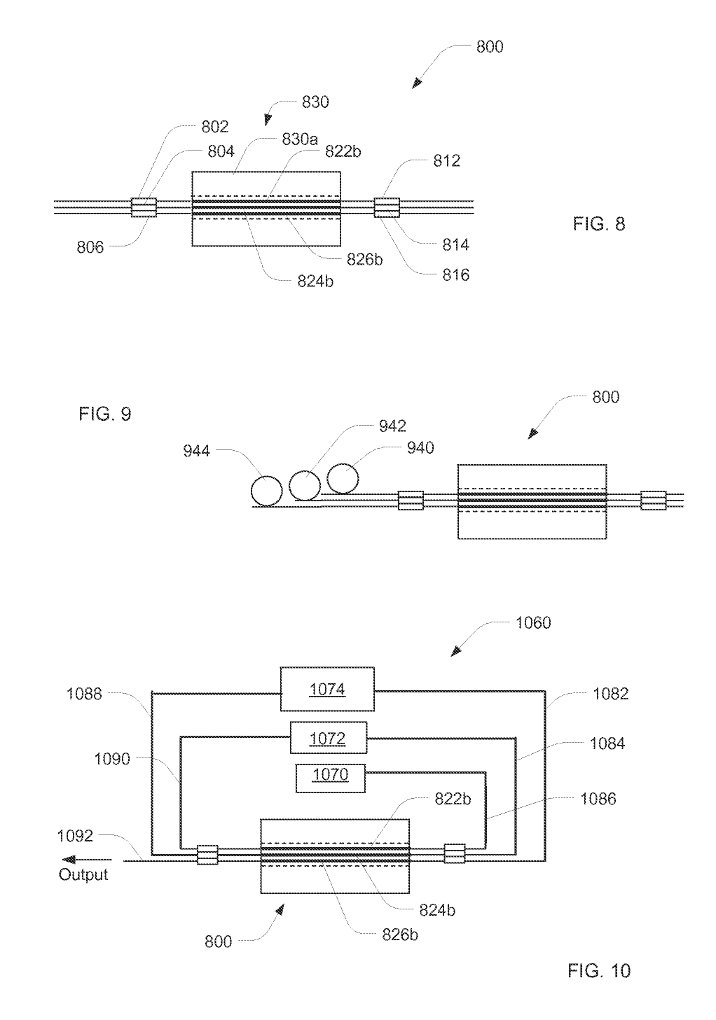

FIG. 9 presents a schematic of an exemplary system comprising the Faraday isolator array 800 of FIG. 8 in conjunction with an array of corresponding fiber lasers. A fiber laser is a laser in which the active gain medium is an optical fiber doped with rare-earth elements. As shown in FIG. 9, each of the optical channels of the Faraday isolator array 800 is arranged in a respective optical communication with a corresponding fiber laser of fiber lasers 940, 942, and 944. While fiber lasers 940, 942, 944 may be the same, generally they differ in terms of at least one of power output, wavelength of operation, and/or regime of operation (such as, for example, pulse duration).

FIG. 10 presents a schematic of an exemplary system comprising the Faraday isolator array 800 of FIG. 8 in optical cooperation with a series of cascade fiber lasers and amplifiers. The embodiment 1060 includes the isolator array 800, cascade fiber laser 1070, and amplifiers 1072, 1074. The polarization-rotating fiber-optic component 822b of the Faraday rotator device of the isolator array 800 is shown to be sandwiched between and linearly integrated to the laser 1070 and the amplifier 1072. The amplifier 1072, in turn, is optically cooperated with the polarization-rotating fiber-optic component 824b. The component 824b is further sequentially coupled to and linearly integrated with the amplifier 1074 and, through the amplifier 1074, with the polarization-rotating fiber-optic component 826b. In a particular embodiment, fiber-optic portions 1082, 1084, and 1086 and fiber-optic portions 1088, 1090, and 1092 interconnecting various active elements of the embodiment of FIG. 10 have the same optical and material properties as fiber-optic components 822b, 824b, and 826b, respectively. Alternatively, however, these interconnecting portions differ from the polarization-rotating fiber-optic components of the Faraday rotator device in at least one of glass type, doping material, and doping concentration. Generally, Verdet constants of materials from which the interconnecting fiber-optic portions 1082, 1084, 1086, 1088, 1090, and 1092 are made differ from those of the polarization-rotating fiber-optic components 822b, 824b, 826b of the Faraday rotator device of the embodiment. In addition, the signs of Verdet constants of the interconnecting fiber-optic portions may differ from those of the polarization-rotating fiber-optic components of the Faraday rotator device.

An alternative schematic of an all-fiber-optic Faraday rotator array 1100 is depicted in FIG. 11 to include fiber-optic components 1104, 1106, 1108 disposed inside a magnetic cell 1110. Each of the polarization-rotating components of the embodiment is further linearly integrated with corresponding fiber-optic elements outside of the magnetic cell 1110 by, for example, fusion splicing, and, in conjunction with the magnetic cell 1110, is adapted to operate as an fiber-optic element rotating the polarization vector of light guided therein via the Faraday effect.

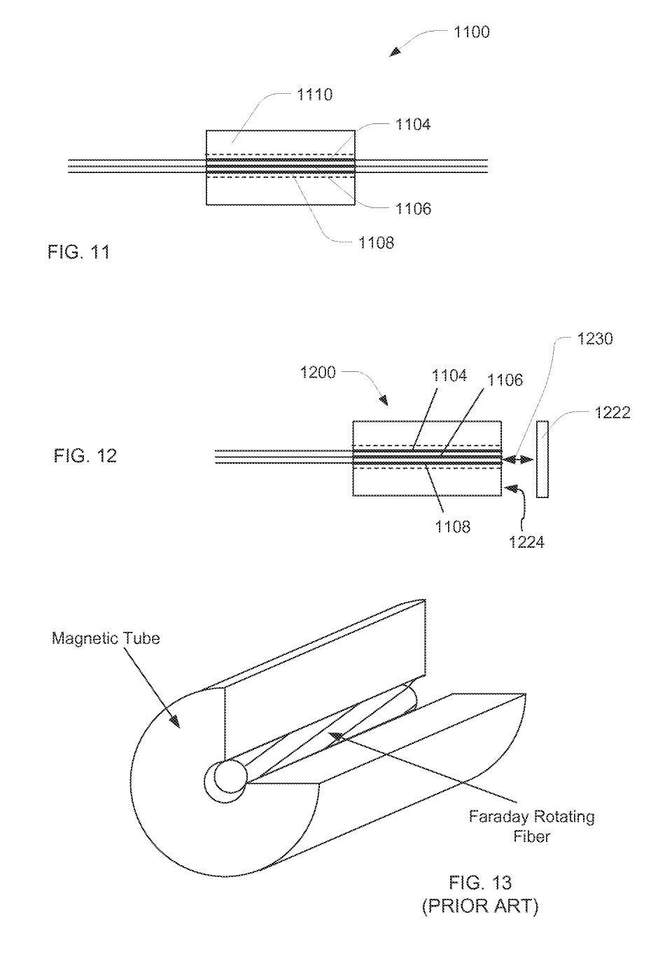

FIG. 12 depicts an exemplary schematic of a Faraday rotator array 1200 optically cooperated, at one end, with a reflector shown as a general reflecting element 1220. The reflective element is adapted to reflect light, propagating in the z-direction along the polarization-rotating fiber-optic components 1104, 1106, 1108 and to return a portion of light, emitted towards the reflective element 1220 from the output 1224 of the rotator 1200, back into the Faraday rotator 1220, as shown by an arrow 1230. In different embodiments, the general reflective element 1220 may include a fiber Bragg grating linearly integrated with the fiber-optic components of the Faraday rotator; a metallic and/or dielectric coatings, disposed on the output facets of the fiber-optic components of the Faraday rotator coating, a stand-alone reflector optionally physically separated from the output 1224, or even a combination thereof. It is appreciated, therefore, that, while the details of optical coupling between the output 1224 and the reflecting element 1222 are not shown, such optical coupling may be arranged using any of means known in the art such as, for example, coupling using optical elements such as lenses or butt-coupling, thin-film deposition, or fusion splicing of otherwise independent fiber-optic elements. It is also appreciated, therefore, that a gap between the output 1224 of the Faraday rotator 1200 and the general reflecting element 1222 is not intended to represent necessarily free space.

In one embodiment, polarization-rotating fiber-optic components of the Faraday rotator 1200 are made of the same glass material doped with the same rare-earth oxide(s). Generally, however, these fiber-optic components are made of different type9s) of glass doped with different rare-earth oxide(s), in which case they may be used for operating at different wavelengths chosen according to optical properties defined in these components by particular types of dopant(s). Generally, therefore, different fiber-optic components of the Faraday rotator 1200 may function differently, for example, one polarization-rotating fiber-optic component may absorb light in a specific spectral band, while another component may absorb light at different wavelengths. In yet another embodiment, the components 1104, 1106, 1108 utilize the same type of glass material but are doped with a rare-earth oxide(s) of different types and/or concentrations.

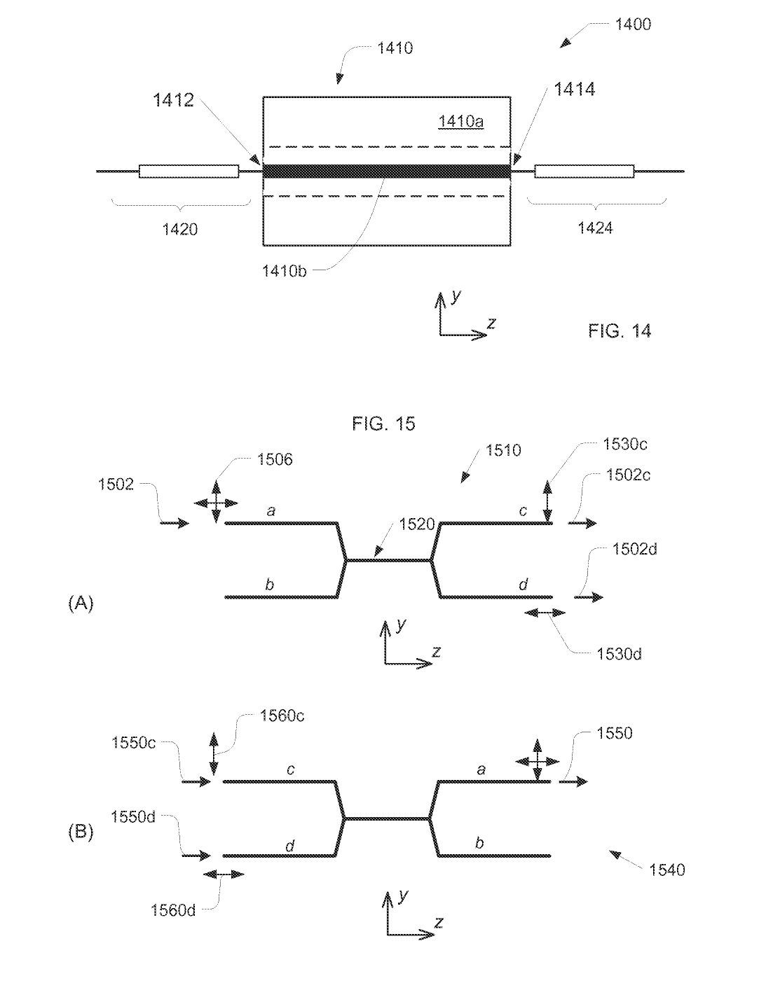

An alternative embodiment 1400 of an all-fiber-optic isolator system is shown in FIG. 14 to include an embodiment 1410 of a Faraday rotator that contains, as discussed above, a magnetic cell 1410a such as a tube made of magnetic material and a fiber-optic component 1410b disposed inside and along the cell 1410a. The fiber-optic component is made of glass doped with a rear-earth based material at doping levels of at least 55 wt % to 85 wt %, in accordance with an embodiment of the invention. The component 1410b is linearly integrated, at each of its ends, respectively corresponding to an input 1412 and an output 1414 of the Faraday rotator 1410, with outside polarizing components 1420, 1424 at least one of which configured to include beam splitters/combiners utilizing polarization-maintaining (PM) fiber optic element. The idea of a non-polarizing fiber-optic beam splitter is readily understood in the art and is not discussed in detail herein. Depending on the configuration, a non-polarizing fiber-optic splitter may split the light wave guided by M optical fibers into N>M independent channels, in a multipoint-to-multipoint link arrangement. (The simplest form of non-polarizing fiber-optic splitter is known as Y-splitter, where M=1, N=2). A non-polarizing fiber-optic combiner is, in the simplest case, a fiber-optic splitter operating in reverse, and multiplexing light waves guided in N independent channels into M<N channels. In contradistinction, embodiments of the present invention take advantage of a fiber-optic beam splitter/combiner the operation of which depends on the state of polarization of light guided within the fiber-optic component.

FIGS. 15A, 15B illustrate a simple X-type fiber-optic splitter that employs PM optical fibers. In general, an embodiment of polarizing fiber-optic splitter is configured to spatially separate components of a guided, inside the fiber optic, light wave according to the polarization content of the guided wave, and to couple the guided wave components having orthogonal states of polarization into different branches of the splitter. For example, a light wave 1502 of a given type of polarization (schematically denoted with arrows 1506) that is coupled into an a input branch of the polarizing fiber-optic beam-splitter 1510 to propagate, along the z-direction, towards a junction 1520 of the splitter 1510, is divided, in the junction 1520, such as to appropriately separate components 1502a, 1502b of the wave 1502 having orthogonal states 1530c, 1530d of polarization into different output branches c, d of the splitter. Operation of a fiber-optic beam combiner 1540 that utilizes polarization-maintaining optical fibers is similar. As shown in FIG. 15B, such a combiner is configured to bring together (or combine) two guided waves 1550c, 1550d with corresponding orthogonal polarizations 1560c, 1560d coupled, respectively, into the branches c, d of the combiner 1540, and to outcouple the (combined) light wave, having a state 1570 of polarization, into a chosen output branch of the combiner (as shown, branch a).

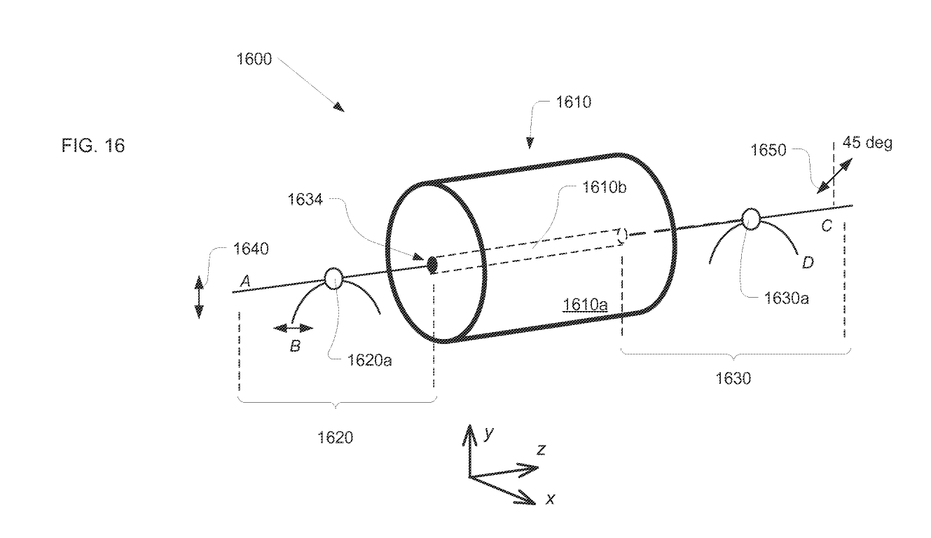

As illustrated schematically in FIG. 16, an embodiment 1600 of an all-fiber-optic isolator of the present invention includes a polarization-rotating fiber-optic based Faraday cell 1610 that contains a rare-earth-doped fiber-optic component 1610b disposed along the length of an inside a tubular magnetic cell 1610a. The embodiment 1600 further contains input and output polarization-maintaining-fiber based beam splitter/combiner components 1620, 1630 that are linearly integrated with respectively corresponding input or output of the fiber-optic component 1610b such as to form an uninterrupted fiber-optic link, optically connecting input fiber-optic branches A, B and output fiber-optic branches C, D through a rare-earth doped component 1610b. Different branches of the splitters/combiners 1620, 1630 are adapted to guide light waves having orthogonal states of polarization.

By way of non-limiting example of operation, and upon forward propagation of light the embodiment 1600 operates as follows. When an input light wave that is linearly polarized, 1640, along a predetermined axis (y-axis as shown) is coupled into the input branch A of the PM fiber-optic based splitter/combiner 1620, the splitter/combiner 1620 transmits this wave, generally in a z-direction, through the junction 1620a towards the Faraday rotator 1610. Upon traversing the Faraday rotator 1610, the polarization vector 1650 of the guided light wave is rotated by 45 degrees. The guided light wave is further coupled into the splitter/combiner 1630 configured to transmit light polarized at k degrees with respect to the predetermined axis into the output branch C and further, towards an optical component or system to which the branch C is coupled. Any portion of the light wave back-reflected into the branch C (m, generally, −z direction as shown) will enter a polarization-rotating component 1610b of the all-fiber-optic link of the embodiment 1600 upon traversing the junction 1630a of the splitter/combiner 1630 and emerge at the end 1634, of the component 1610b of the Faraday cell 1610, with have its polarization vector additionally rotated by 45 degrees. The resulting state of the back-reflected light wave at a splice 1634 between the component 1610b and the splitter/combiner 1620 is orthogonal to the state of polarization supported by the A branch of the splitter/combiner 1620. Since the branch B of the splitter/combiner 1620 is configured to guide light having polarization orthogonal to that supported by the branch A, the back-reflected light wave is outcoupled through the branch B. A skilled artisan will appreciate the fact that an embodiment 1600 of the invention isolates a laser source coupled into the branch A of the embodiment from the unwanted optical feedback in formed in reflection downstream the optical path.

It should be noted that unconventionally high levels of doping, with rare-earth materials, of glass matrix of the fiber-optic components of the Faraday cell of the invention assure that rotation by 45 degrees or so of the vector of linear polarization of light guided by the fiber-optic components of the Faraday cell is accomplished at propagation lengths of or about several centimeters (for example, about 5 to 10 cm).

The present invention may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes which come within the meaning and range of equivalency of the claims are to be embraced within their scope. For example, embodiments implementing arrays of all-fiber-optic based isolators employing PM fiber-optic beam splitter/combiners can be readily configured for use with a plurality of laser sources (such as fiber lasers, for example) and fiber-optic amplifiers.

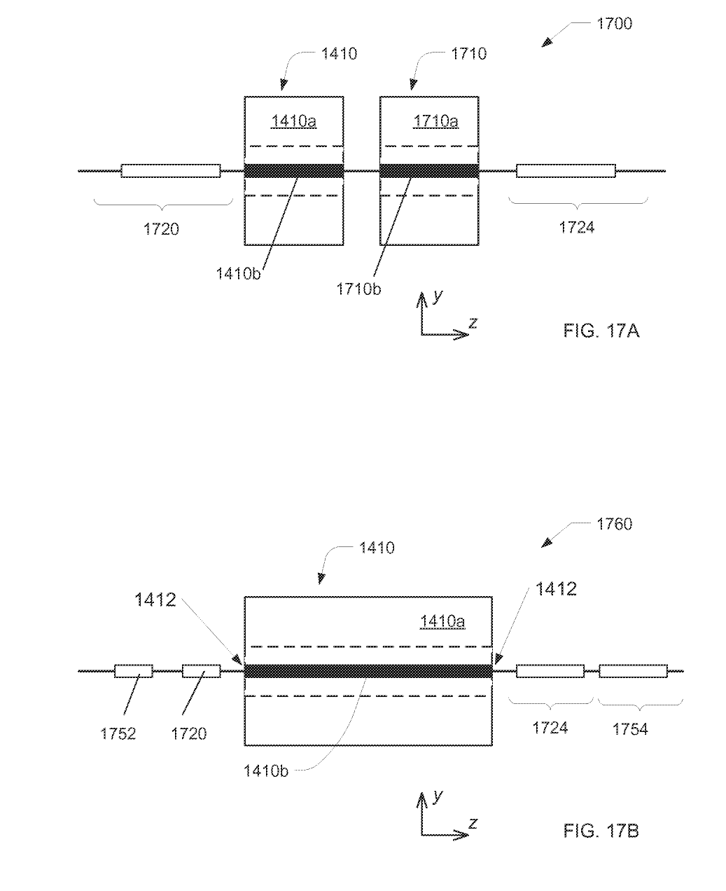

While the preferred embodiments of the present invention have been illustrated in detail, it should be apparent that modifications and adaptations to those embodiments may occur to one skilled in the art without departing from the scope of the present invention as set forth in the following claims. For example, an alternative embodiment of the invention may include multiple Faraday rotators 1410, 1710 (each of which contains a corresponding polarization-rotating fiber optic component 1410b, 1710b enclosed in a corresponding magnetic cell 1410a, 1710a). Alternatively or in addition, an embodiment of the invention may include multiple polarization-maintaining fiber-optic beam-splitter, arranged in sequence, or in parallel, or both sequentially and in parallel with one another. An example of a sequence of multiple PM fiber-optic beam-splitters 1720, 1752 and 1724, 1754 used with an embodiment 1760 is shown in FIG. 17B.

What is claimed is:

1. A fiber-optic (FO) device having first and second light ports and a light-path defined between the first and second light ports, the FO device comprising:
a magnetic cell having a hollow;
a multicomponent-glass optical fiber having two ends and disposed in said hollow, the multicomponent-glass optical fiber containing, in the amount between 55 weight-percent and 85 weight-percent, a rare-earth oxide dopant selected from the group consisting of Pr₂O₃, Nd₂O₃, Pm₂O₃, Sm₂O₃, Eu₂O₃, Gd₂O₃, Tb₂O₃, Dy₂O₃, Ho₂O₃, Er₂O₃, Tm₂O₃, Yb₂O₃, La₂O₃, Ga₂O₃, Ce₂O₃, and Lu₂O₃;
a first polarization-maintaining (PM) optical fiber beam splitter defining the first port of the FO device, a terminal of the first PM optical fiber beam splitter being fusion-spliced with one end of said multicomponent-glass optical fiber; and
a second PM optical beam splitter defining the second port of the FO device, a terminal of the second PM optical fiber beam splitter being fusion-spliced with another of said multicomponent-glass optical fiber,
wherein said light-path is devoid of free-space regions.

2. A FO device according to claim 1, configured to operate as a FO-based Faraday isolator that is spatially continuous and devoid of stand-alone optical elements.

3. A plurality of FO devices according to claim 1, configured as an all-FO Faraday isolator array.

4. A FO device according to claim 1, configured to rotate a vector of polarization of linearly-polarized light propagating through the FO device by an angle of 45 degrees, wherein a length of said multicomponent optical fiber does not exceed approximately 10 cm.

5. A FO device according to claim 1, further comprising:
at least one of glass network formers selected from the group consisting of SiO₂, GeO₂, P₂O₅, B₂O₃, TeO₂, Bi₂O₃, and Al₂O₃;
a glass network intermediate; and
a glass network modifier.

6. A fiber-optic (FO) beam-splitter having first and second ports, the FO beam-splitter comprising:
a first FO-component defining a first port of said FO beam-splitter and having at least three branches operably integrated at a first junction that is configured to spatially redirect a first fiber mode of said input FO component into at least one branch thereof based on polarization state of said guided fiber mode, the first fiber mode characterized by a first polarization vector;
a second FO-component defining a second port of said FO beam-splitter and having at least three branches operably integrated at a second junction that is configured to spatially redirect a second fiber mode guided by said second FO-component into at least one branch thereof based on polarization state of said guided fiber mode, the second fiber mode characterized by a second polarization vector forming an angle with the first polarization vector; and
an intermediate FO-component that contains, in the amount between 55 weight-percent and 85 weight-percent, a rare-earth oxide dopant selected from the group consisting of Pr₂O₃, Nd₂O₃, Pm₂O₃, Sm₂O₃, Eu₂O₃, Gd₂O₃, Tb₂O₃, Dy₂O₃, Ho₂O₃, Er₂O₃, Tm₂O₃, Yb₂O₃, La₂O₃, Ga₂O₃, Ce₂O₃, and Lu₂O₃, and that is fusion-spliced between branches of the first and second FO-components, the intermediate FO component configured
to receive and guide the at least one of said first and second fiber modes; and
when exposed to a magnetic field, to rotate a vector of polarization of the mode being guided from an initial vector to a final vector, the initial and final vectors chosen from a group consisting of the first and second polarization vectors.

7. A FO A FO beam-splitter according to claim 6, wherein the angle includes an angle of approximately 45 degrees and a length of said intermediate FO-portion does not exceed approximately 10 cm.

8. A FO beam-splitter according to claim 6, configured to define an optical path between the first and second ports, wherein said optical path is devoid of free-space regions.

9. A FO beam splitter according to claim 6, wherein light guided by said FO beam splitter from the second port through the intermediate FO-component is redirected, by the first junction, towards a branch of the first FO-components that is different from the first port.

10. A FO beam-splitter according to claim 6, configured as an all-FO Faraday isolator.

11. A plurality of FO beam-splitters according to claim 6, configured as an all-FO Faraday isolator array.

12. A FO beam-splitter according to claim 6, wherein the intermediate FO-component further contains:
at least one of glass network formers selected from the group consisting of SiO₂, GeO₂, P₂O₅, B₂O₃, TeO₂, Bi₂O₃, and Al₂O₃;
a glass network intermediate; and
a glass network modifier.

13. A method for operating a fiber-optic (FO) device having first and second light ports and a light-path defined between the first and second light ports, the method comprising:
transmitting light from the first port through a first polarization-maintaining (PM) FO beam-splitter to a multicomponent-glass optical fiber having
two ends, one of which is fusion-spliced with the first PM FO beam-splitter, and
a rare-earth oxide dopant, in the amount between 55 weight-percent and 85 weight-percent, selected from the group consisting of Pr₂O₃, Nd₂O₃, Pm₂O₃, Sm₂O₃, Eu₂O₃, Gd₂O₃, Tb₂O₃, Dy₂O₃, Ho₂O₃, Er₂O₃, Tm₂O₃, Yb₂O₃, La₂O₃, Ga₂O₃, Ce₂O₃, and Lu₂O₃;
transmitting said light through the multicomponent-glass optical fiber to a second PM FO beam-splitter that is fusion-spliced with another end of the multicomponent-glass optical fiber and, upon such transmission, rotating a polarization vector of said light by approximately 45 degrees; and
transmitting said light through the second PM FO beam-splitter through a second port to a field-of-view outside the second PM FO beam-splitter.

14. A method according to claim 13, wherein the transmitting light from the first port through a first polarization-maintaining (PM) FO beam-splitter to a multicomponent-glass optical fiber includes transmitting light to a multicomponent-glass optical fiber containing
at least one of glass network formers selected from the group consisting of SiO₂, GeO₂, P₂O₅, B₂O₃, TeO₂, Bi₂O₃, and Al₂O₃;
a glass network intermediate; and
a glass network modifier.

15. A method according to claim 13, wherein transmitting light through said FO device between the first and second ports includes transmitting light along an optical path that is devoid of free-space regions.

16. A method according to claim 13, wherein the transmitting said light through the multicomponent-glass optical fiber to a second PM FO beam-splitter includes transmitting said light through a length of the multicomponent-glass optical fiber that does not exceed approximately 10 cm.

17. A method according to claim 13, wherein transmitting light through said FO device between the first and second ports includes transmitting light through an all-optical-fiber Faraday rotator.
